(19) United States
(12) Patent Application Publication
(10) Pub. No.: US 2021/0341857 A1
(43) Pub. Date: Nov. 4, 2021

(54) PRINT AGENT FILTRATION

(71) Applicant: Hewlett-Packard Development Company, L.P., Spring, TX (US)

(72) Inventors: Igor Chertov, Ness Ziona (IL); Sergei Trifonov, Ness Ziona (IL); Doron Schlumm, Ness Ziona (IL)

(73) Assignee: Hewlett-Packard Development Company, L.P., Spring, TX (US)

(21) Appl. No.: 17/280,967

(22) PCT Filed: Nov. 29, 2018
(86) PCT No.: PCT/US2018/063104

§ 371 Date: Mar. 29, 2021

(51) Int. Cl. G03G 15/10

(52) U.S. Cl. CPC G03G 15/104

(57) ABSTRACT

A print agent filtration apparatus is disclosed. The filtration apparatus is to remove non-liquid contaminant from liquid carrier. The apparatus comprises an electrode having a first surface, wherein the electrode is to generate an electric field towards liquid carrier containing non-liquid contaminant. The apparatus further comprises a second surface to accumulate non-liquid contaminant removed from the liquid carrier, the second surface being formed at least in part from a ceramic and movable relative to the first surface. A gap between the first surface and the second surface is substantially constant over the extent of the first surface. The first surface and the second surface define a passage therebetween through which the liquid carrier may pass. An electric field formed between the first surface and the second surface is to act on the liquid carrier, to thereby cause non-liquid contaminant to adhere to the second surface. A method and a print apparatus are also disclosed.

### BACKGROUND

In some printing systems, print agent is applied to a printable substrate via a roller, or multiple rollers. The print agent may comprise a combination of a non-liquid contaminant in a liquid carrier, such that a portion of the non-liquid contaminant is transferred to the printable substrate and at least some of the liquid carrier can be removed from the apparatus.

After the liquid carrier has transported the non-liquid contaminant, the liquid carrier may remain contaminated with non-liquid contaminant that has not been transferred onto the printable substrate, and with other material, such as particles (e.g. dust) from the printable substrate.

### BRIEF DESCRIPTION OF DRAWINGS

Examples will now be described, by way of non-limiting example, with reference to the accompanying drawings, in which:

FIG. 1 is a simplified illustration of an example of an end view of a print agent filtration apparatus;

FIG. 2 is a simplified illustration of a further example of an end view of a print agent filtration apparatus;

FIG. 3 is a simplified illustration of a further example of a perspective view of a print agent filtration apparatus;

FIG. 4 is a flowchart of an example of a print agent filtration method;

FIG. 5 is a flowchart of a further example of a print agent filtration method;

FIG. 6 is a simplified schematic of an example of a print apparatus; and

FIG. 7 is a simplified schematic of a further example of a print apparatus.

### DETAILED DESCRIPTION

The disclosure presented herein relates to an apparatus for filtering used print agent. More particularly, the disclosure relates to a filtration apparatus for removing non-liquid contaminant from liquid carrier used in print agent. Aspects of the disclosure may be implemented in printing systems using various different printing technologies. Some examples are described in the context of one particular printing technology, liquid electrophotography.

In a liquid electrophotography (LEP) printing system, print agent, such as ink, may be used which is formed of a combination of non-liquid contaminant (e.g. material such as solid or partially solid material) and a liquid carrier, such as imaging oil. The print agent is stored in a reservoir and may be transferred using a binary ink developer (BID). Each BID transfers print agent of a particular colour, so an LEP printing system may include, for example, seven BIDs. Some of the non-liquid part of the print agent from a BID is selectively transferred from a developer roller of the BID in a layer of substantially uniform thickness to an imaging plate of a photoconductive imaging plate, such as a photo imaging plate (PIP). The selective transfer of print agent may be achieved through the use of electrically-charged (or electrostically-charged) print agent. Thus, the non-liquid component of the print agent may be electrically-charged (or electrostatically-charged) while the liquid carrier carries no electrical or electrostatic charge. The entire imaging plate, which may form part of or be located on a rotatable roller or drum, may be electrostatically charged, using a charging device, such as charge roller (e.g. a ceramic charge roller), which rotates relative to the imaging plate. Areas on the imaging plate representing an image to be printed may then be discharged, for example by forming a latent image on the imaging plate using a laser beam or other type of light. Non-liquid parts of the print agent are transferred to those portions of the imaging plate that have been discharged. The imaging plate may transfer the non-liquid print agent to another roller, such as an intermediate transfer member (ITM), which may be covered by a replaceable print blanket. The non-liquid print agent may subsequently be transferred onto a printable substrate, such as paper, while the liquid part of the print agent (e.g. the liquid carrier) may be removed from the roller(s), and received into a used liquid carrier container, for example.

In other printing systems, the imaging plate may comprise a surface other than a PIP. For example the imaging plate may comprise a sleeve formed or placed around a roller or drum. Such a sleeve may be formed from a material which can be selectively charged and discharged. The term “imaging plate” may be referred to as an imaging surface. The imaging surface may, in some examples, comprise the surface of a photoconductive imaging unit or component.

Even though a large proportion of the non-liquid print agent may be transferred to the printable substrate, the used liquid carrier may still contain non-liquid debris, such as non-liquid parts of the print agent that have not been transferred onto a roller and/or onto the printable substrate, particles that have been transferred from components of the printing system into the liquid carrier, particles of dust from the printable substrate (sometimes referred to as paper dust) and other particles or material that contaminate the liquid carrier. According to examples disclosed herein, a mechanism is provided for removing such non-liquid contaminant from used or liquid carrier such that, once filtered, the used liquid carrier may be reused or recycled. The filtration apparatus uses an electric field to separate non-liquid contaminant from the liquid carrier, and this filtration mechanism is able to provide improved performance and efficiency over existing print agent filtration methods.

An aspect of the disclosure relates to a print agent filtration apparatus which may, for example, form part of, or be used in conjunction with a print apparatus to filter print agent used in a printing operation.

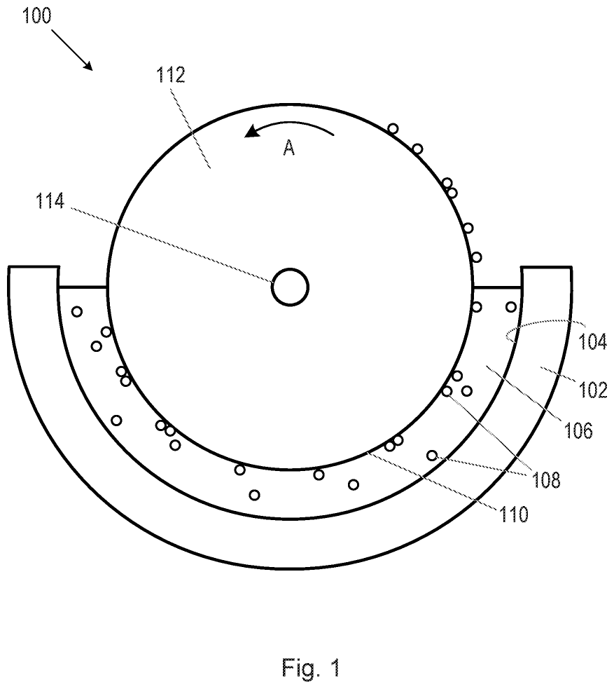

Referring to the drawings, FIG. 1 is a simplified illustration of an example of a print agent filtration apparatus 100. The filtration apparatus 100 is for removing non-liquid (e.g. solid) contaminant from liquid carrier. The filtration apparatus 100 comprises an electrode 102 having a first surface 104, wherein the electrode is to generate an electric field towards liquid carrier 106 containing non-liquid contaminant 108. The electrode 102 may, for example, be electrically connected to a power supply (e.g. a high-voltage power supply) (not shown in FIG. 1). The electrode 102 may, for example, comprise a negative electrode. The filtration apparatus 100 further comprises a second surface 110 to accumulate non-liquid contaminant removed from the liquid carrier 106. The second surface 110 at least in part from a ceramic material, and is movable relative to the first surface 104. In some examples, such as the example shown in FIG. 1, the second surface 110 may comprise, or be formed on, a surface of a roller or a drum 112 which is rotatable relative to the first surface 104. For example, the roller or drum 112 may be rotatable about a longitudinal axis 114 in a direction shown by the arrow A. In other examples, the second surface 110 may comprise the surface of a ceramic coating, blanket, sleeve or belt formed on or mounted around the roller or drum 112. The second surface 100 and/or the roller or drum 112 on which the second surface is formed or mounted may be electrically grounded. Thus, an electric field is generated from the electrode 102 towards the second surface 110.

A gap between the first surface 104 and the second surface 110 is substantially constant over the extent of the first surface. Thus, in the example shown in FIG. 1, the first surface 104 follows (at least to some extent) the shape of the second surface 110. In some examples, the gap between the first surface 104 and the second surface 110 may be between around 1 millimetre and 3 millimetres. In some examples, the gap between the first surface 104 and the second surface 110 may be between around 1 millimetre and 2 millimetres. In one example, the gap between the first surface 104 and the second surface 110 may be around 1.5 millimetres. In other examples, the gap may be smaller or larger than the gaps given above. A relatively large gap of between 1 millimetre and 3 millimetres helps to restrict the increase in pressure caused by the liquid carrier 106.

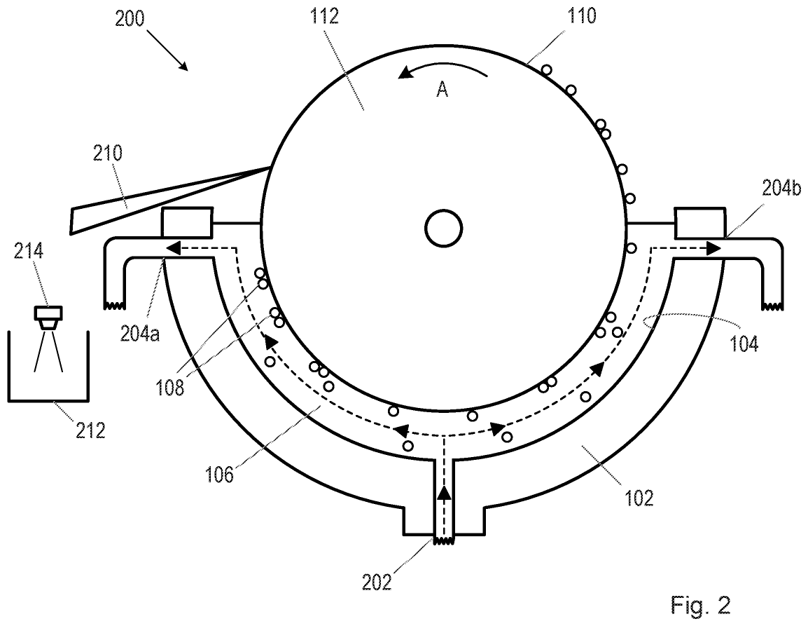

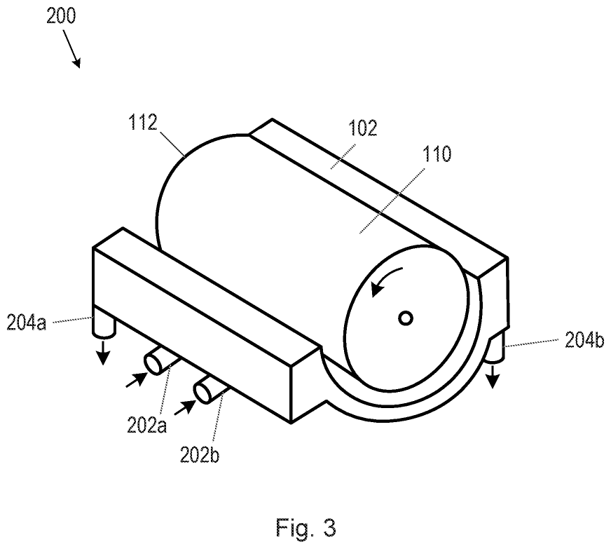

The first surface 104 and the second surface 110 define a passage therebetween through which the liquid carrier 106 may pass. As is discussed below with reference to FIGS. 2 and 3, liquid carrier may flow into the passage between the first and second surfaces 104, 110 in a number of different ways, and the number and positions of inlets for providing liquid carrier to the passage determine the direction of flow of liquid carrier between the first and second surfaces. Seals (e.g. dynamic seals) (not shown) may be provided between the electrode 102 and the second surface 110 and/or the roller or drum 112 so that liquid carrier 106 is maintained within the filtration apparatus 100.

An electric field formed between the first surface 104 and the second surface 110 is to act on the liquid carrier, to thereby cause non-liquid contaminant 108 to adhere to the second surface. As noted above, in some printing systems, electrically-charged or electrostatically-charged print agent may be used and, in such systems, electrically-charged non-liquid print agent contaminant may be present in a liquid carrier. Therefore, the used liquid carrier may contain electrically-charged non-liquid print agent contaminant that has not been transferred onto the printable substrate. The generated electric field will act on the electrically-charged contaminant, causing it to be attracted to the second surface 110. While the electric field exists between the first surface 104 and the second surface 110, the electrically-charged contaminant will be caused to accumulate on and adhere to the second surface. In addition to electrically-charged contaminant and particles, non-electrically-charged contaminant, such as particles from the printable substrate (e.g. paper dust) may become electrostatically-charged as a result of the generated electric field. As such, any material that becomes electrostatically-charged is also attracted to the second surface 110. Since the liquid part (e.g. imaging oil) in the liquid carrier 106 is not electrically-charged, and does not become electrostatically-charged, it is not affected by the generated electric field. As a result, the non-liquid contaminant 108 in the liquid carrier 106 accumulates on the second surface 110.

As shown in the example of FIG. 1, the second surface 110 is partially submerged in the liquid carrier 106. As the roller or drum 112 on which the second surface 110 is formed or mounted rotates, non-liquid contaminant 108 that has adhered to the second surface is moved out of the liquid carrier 106 such that it can be removed from the second surface, for example using methods described below. Once the non-liquid contaminant 108 has been removed from the liquid carrier 106, the liquid carrier can be considered to have been filtered (i.e. the non-liquid contaminant has been removed from the liquid carrier). The filtered liquid carrier may then be removed from the passage defined between the first surface 104 and the second surface 110, for example to be reused or recycled.

Since the second surface 110 is formed at least in part from a ceramic material, a strong electric field may be used (e.g. by applying a high voltage), thereby creating a strong attraction of the non-liquid contaminant and the second surface. In one example, the second surface 110 comprises a relatively thick ceramic coating formed on the surface of the roller or drum 112. Since a ceramic material is used, a particularly high voltage may be used to generate the electric field, without the risk of sparking. In general, the higher the voltage applied to the electrode 102, the greater the development (e.g. attraction) of non-liquid contaminant 108 on the second surface 110. However, for various reasons (e.g. energy reduction or safety), it may be intended that the voltage is restricted to a particular level. Thus, in some examples, a voltage of between around 3.5 kiloVolts (kV) and around 4.5 kV may be applied to the electrode 102. In other examples, a voltage of between around 4 kV and around 4.2 kV may be applied to the electrode 102. In one example, a voltage of around 4.1 kV may be applied to the electrode 102.

As will be apparent, the larger the second surface 110, the greater the amount of non-liquid contaminant 108 that can be removed from the liquid carrier 106. However, it may not be feasible to provide a particularly large drum or roller 112 having or supporting the second surface 110. In some examples, it may be intended that the filtration apparatus 100 is relatively compact. Thus, in some examples, the roller or drum 112 may have a diameter of between around 100 millimetres and around 200 millimetres. In other examples, the roller or drum 112 may have a diameter of between around 110 millimetres and around 130 millimetres or between around 160 millimetres and around 180 millimetres. In one example, the roller or drum 112 may have a diameter of around 120 millimetres. The length of the roller or drum 112 may also be selected based on the intended surface area of the second surface 110 able to accumulate non-liquid contaminant 108. In some examples, the roller or drum 112 may have a length of between around 300 millimetres and around 500 millimetres. In other examples, the roller or drum 112 may have a length of between around 340 millimetres and around 360 millimetres or between around 440 millimetres and around 460 millimetres. In one example, the roller or drum 112 may have a length of around 350 millimetres.

FIGS. 2 and 3 are simplified illustrations of a further example of a print agent filtration apparatus 200. FIG. 2 is an end view of the filtration apparatus 200, and FIG. 3 is a perspective view of part of the filtration apparatus 200.

In the example shown in FIGS. 2 and 3, the filtration apparatus 200 includes the electrode 102 having the first surface 104, and the second surface 110 formed on, or mounted on, the drum or roller 112. The filtration apparatus 200 may further comprise an inlet 202 to receive the liquid carrier containing non-liquid contaminant 108. The filtration apparatus 200 may further comprise an outlet 204 to allow filtered liquid carrier to flow away from the apparatus 200. In some examples, multiple inlets 202 and/or multiple outlets 204 may be provided.

In FIG. 2, the general direction of flow of liquid carrier through the passage defined between the first surface 104 and the second surface 110 is shown by dashed arrows. In this example, liquid carrier 106 flows through first and second inlets 202a, 202b (just one inlet is visible in FIG. 2) located generally below the roller or drum 112, and flows through the passage towards first and second outlets 204a and 204b. By providing the liquid carrier 106 via multiple inlets, and removing the filtered liquid carrier via multiple outlets, a large proportion of the second surface 110 can be used to accumulate non-liquid contaminant, meaning a larger volume of liquid carrier can be filtered at a time.

FIG. 3 shows an example of a particular arrangement of inlets 202 and outlets 204. In some examples, the inlet 202 may comprise multiple apertures 202a, 202b positioned at regular intervals along the length of the second surface 110. By spacing the inlet apertures 202a, 202b evenly (i.e. at regular intervals) over the length of the second surface 110 (e.g. along the length of the roller or drum 112), an even flow distribution of the liquid carrier 106 can be achieved. By achieving a uniform flow of the liquid carrier 106 over the second surface 110, the filtration of the liquid carrier can be improved, and even optimised. While, in the example shown in FIGS. 2 and 3, two inlets 202a, 202b are provided, in other examples, a greater number of inlets may be provided, and these may be based evenly (e.g. positioned at regular intervals) along the length of the second surface 110.

In some examples, the outlet 204 may comprise multiple outlet apertures 204a, 204b positioned at opposite ends of the second surface 110. In the example shown in FIG. 3, a first outlet aperture 204a is provided at a first end of the second surface 110 (and at a first end of the roller or drum 112) and a second outlet aperture 204b is provided at a second end of the second surface (and at a second end of the roller or drum). By providing outlets at, or near to, the ends of the second surface 110/roller or drum 112, the liquid carrier 106 is able to flow over a large proportion of the second surface 110 in the passage formed between the first surface 106 and the second surface, thereby increasing or maximising the available filtration effect. In other words, the largest possible proportion of the second surface 110 can be used for accumulating non-liquid contaminant 108 from the liquid carrier 106. It will be appreciated that, while two outlets 204a, 204b are provided in the example shown in FIGS. 2 and 3, in other examples, a greater number of outlets may be provided, and these may be positioned at or near to the ends of the second surface 110.

According to some examples, the filtration apparatus 200 may further comprise a displacement element 210 to displace non-liquid contaminant 108 from the second surface 110. The displacement element 210 may, in some examples, comprise a scraper or blade to scrape or wipe non-liquid contaminant that has accumulated on the second surface 110 off the second surface. The filtration apparatus 200 may, in some examples, further comprise a receptacle or bin 212 to receive non-liquid contaminant 108 that is displaced from the second surface 110 by the displacement element 210. For example, displaced material or contaminant may be caused to fall into the receptacle 212. The displaced material or contaminant in the receptacle 212 may then be removed, for example for disposal.

In some examples, the filtration apparatus 200 may further comprise a sensor 214 to monitor and amount of non-liquid contaminant in the receptacle 212. If the sensor 214 detects that the amount of material in the receptacle 212 meets or exceeds a defined level or volume, then an alert signal may be generated. In response to another signalling generated, a user or operator may be notified or, in some examples, the filtration apparatus may be paused or deactivated, to prevent further material or contaminant from entering the receptacle 212.

In examples where the displacement element 210 comprises a blade, the second surface 110 may be movable relative to the blade, such that the blade is to displace non-liquid contaminant 108 from the second surface as the second surface moves relative to the blade. For example, as the roller or drum 112 (and therefore the second surface 110) rotates in the direction of the arrow A (see FIG. 2), the blade 210, which is stationary relative to the second surface, displaces non-liquid contaminant 108 from the second surface, and the removed contaminant can be collected in the receptacle 212.

The displacement element 210 (e.g. the blade) may, in some examples, be formed from metal. In this way, the displacement element 210 may effectively remove all, or substantially all of the non-liquid contaminant accumulated on the second surface 110. Since the second surface 110 is formed at least in part from a ceramic material, a metal blade 210 may be used without the risk of damaging the second surface. Thus, effective displacement of non-liquid contaminant 108 from the second surface 110 can be achieved while ensuring that wear or damage to the second surface is prevented or kept to a minimum.

The rate of rotation of the drum or roller 112 (and therefore the second surface 110) may be chosen to provide suitable duration within the liquid carrier 106, such that the non-liquid contaminant 108 has sufficient time to move towards, and adhere to, the second surface. In some examples, the drum or roller 112 (and/or the second surface 110) may rotate at a rate of between around 0.2 revolutions per minute and around 0.5 revolutions per minute. In some examples, the drum or roller 112 (and/or the second surface 110) may rotate at a rate of around 0.25 revolutions per minute.

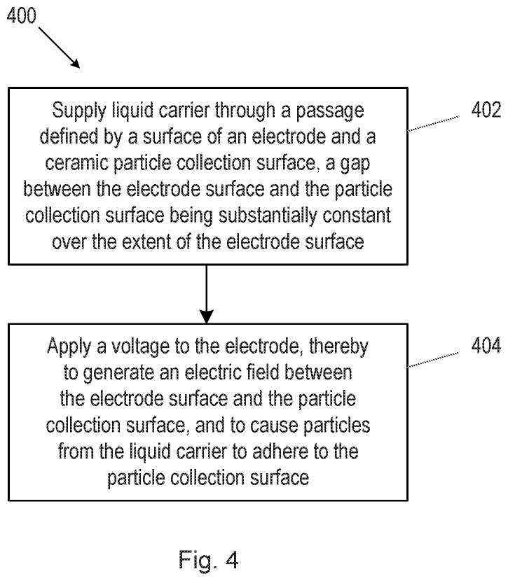

Another aspect of the disclosure relates to a method for filtering print agent. FIG. 4 is a flowchart of an example of a print agent filtration method 400. The method 400 may be to remove particles from liquid carrier, such as the liquid carrier 106. The method 400 comprises, at block 402, supplying liquid carrier 106 through a passage defined by a surface 104 of an electrode 102 and a ceramic particle collection surface 110, a gap between the electrode surface and the particle collection surface being substantially constant over the extent of the electrode surface. At block 404, the method 400 further comprises applying a voltage to the electrode 102, thereby to generate an electric field between the electrode surface 104 and the particle collection surface 110, and to cause particles from the liquid carrier 106 to adhere to the particle collection surface. Thus, the electrode surface may comprise the first surface discussed above, and the particle collection surface may comprise the second surface discussed above.

The flow rate of the liquid carrier 106 (i.e. the rate at which the liquid carrier is supplied into the passage between the first surface (e.g. the electrode surface) 104 and the second surface (e.g. the particle collection surface) 110 may be selected based on the intended adherence of non-liquid contaminant to the second surface. In some examples, the liquid carrier 106 may be supplied into the passage at a rate of between around 15 litres per minute and around 25 litres per minute. In other examples, the liquid carrier 106 may be supplied into the passage at a rate of between around 19 litres per minute and around 21 litres per minute. In one example, the liquid carrier 106 may be supplied into the passage at a rate of around 20 litres per minute. If the flow rate is too high, then liquid carrier 106 flowing into the passage may cause non-liquid contaminant that has accumulated on and adhered to the second surface 110 to be displaced from (e.g. washed away from) the second surface prematurely (i.e. while the non-liquid contaminant is still submerged in the liquid carrier 106). Therefore, the flow rate of the liquid carrier 106 is chosen to be low enough that contaminant is not displaced from the second surface 110, but high enough that liquid carrier can be filtered (i.e. non-liquid contaminant can be removed from the liquid carrier) at an intended rate.

The efficiency of the filtering of the liquid carrier 106 may be affected (e.g. improved) by appropriately selecting the voltage applied to the electrode 102, as discussed above. For example, the voltage supplied to the electrode may comprise a voltage of between around 3.5 kV and around 4.5 kV and may, in one example, may comprise a voltage of around 4.1 kV.

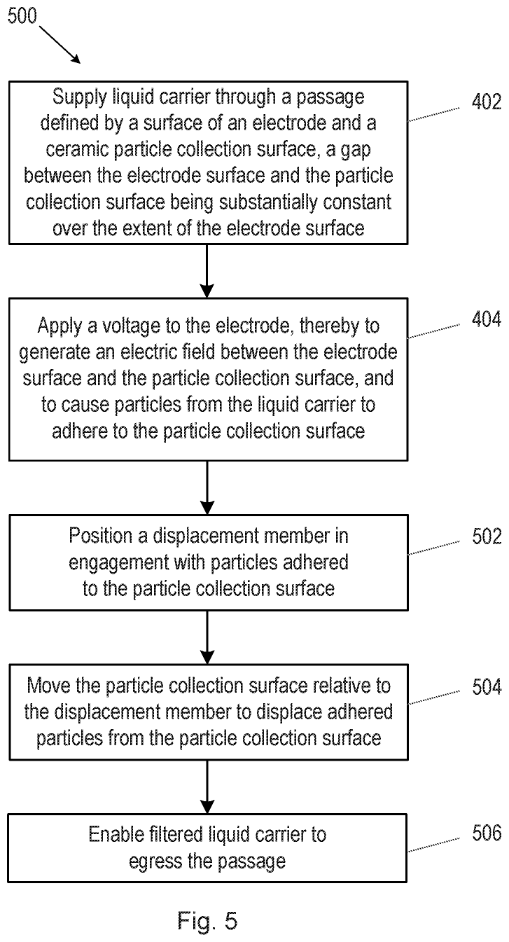

FIG. 5 is a flowchart of a further example of a print agent filtration method 500. The method 500 may comprise a block or blocks of the method 400 discussed above. The method 500 may further comprise, at block 502, positioning a displacement member 210 in engagement with particles 108 adhered to the particle collection surface 110. In some examples, the method 500 may further comprise, at block 504, moving the particle collection surface 110 relative to the displacement member 210 to displace adhered particles 108 from the particle collection surface. The displacement member 210 may, in some examples, comprise a blade, as discussed above

At block 506, the method 500 may, in some examples, further comprise enabling filtered liquid carrier to egress the passage. For example, an outlet, or multiple outlets, may be provided via which filtered may flow, to move away from the filtration apparatus 100, 200. Filtered liquid carrier may, in some examples, be received in a container or reservoir reused or recycled.

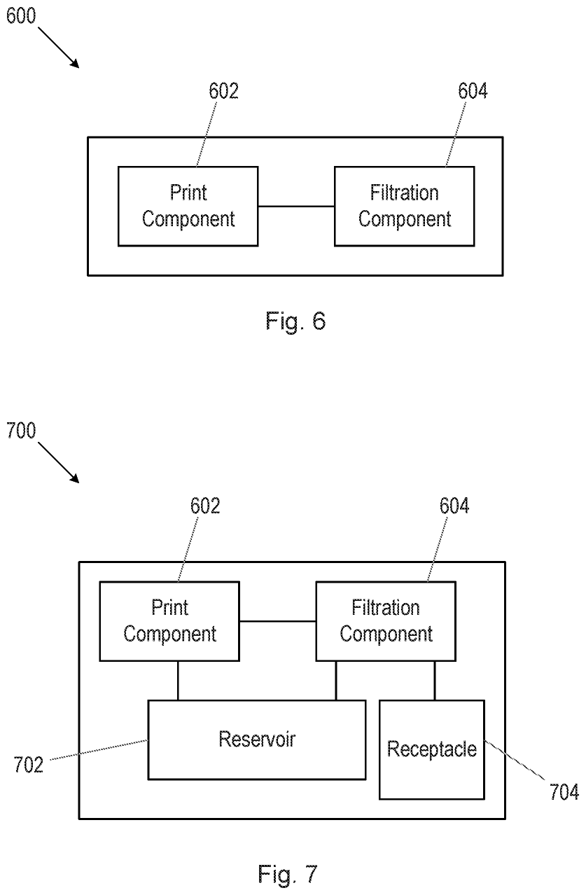

According to another aspect, the disclosure relates to a print apparatus. FIG. 6 is a simplified schematic of an example of a print apparatus 600. The print apparatus 600 may, for example, comprise a printer, such as a liquid electrophotography printer. The print apparatus 600 comprises a print component 602 to print onto a printable substrate during a printing operation. The print component 602 may, for example, comprise various components or subcomponents, such as a print head. The print apparatus 600 further comprises a filtration component 604 to remove non-liquid contaminant from liquid carrier used in the printing operation. The filtration component 604 comprises an electrode 102 having an electrode surface 104. The filtration component 604 further comprises a ceramic material receiving surface to receive non-liquid contaminant 108 removed from the liquid carrier, the receiving surface moveable relative to, and spaced apart from, the electrode surface 104 to form a flow region through which the liquid carrier may pass. When an electric current is applied to the electrode surface 104, an electric field is formed between the electrode surface and the receiving surface 110, thereby causing non-liquid contaminant 108 in the liquid carrier to adhere to the receiving surface. Thus, the filtration component 604 may comprise or form part of the filtration apparatus 100, 200 discussed above.

FIG. 7 is a simplified schematic of a further example of a print apparatus 700. The print apparatus 700 may comprise a component of components of the print apparatus 600 discussed above. In some examples, the filtration component 604 may further comprise a displacement member 210 to displace non-liquid contaminant 108 from the receiving surface 110. The displacement member 210 may, for example, comprise a scraper or blade, such as a metal blade. The print apparatus 700 may further comprise a reservoir 702 to receive filtered liquid carrier from the flow region. As noted above, the filtered liquid carrier (i.e. the liquid carrier with the non-liquid contaminant having been removed) may, in some examples, be extracted and reused or recycled.

The print apparatus 700 may, in some example, further comprise a receptacle 704 to receive non-liquid contaminant 108 displaced from the receiving surface 110. The receptacle 704 (e.g. a bin) may collect the non-liquid contaminant 108 removed from the receiving surface 110 ready for disposal.

The filtration component 604 of the print apparatus 600, 700 may, in some examples, operate continuously during operation of the print apparatus. In other examples, the filtration component 604 may be operated intermittently, for example at intervals. In such examples, liquid carrier 106 may be stored in a reservoir, for example, until the filtration component 604 is in operation. The liquid carrier 106 may then be fed into the filtration component 604 (e.g. into the flow region between the receiving surface and the electrode) to be filtered.

In some examples, a self-cleaning operation may be performed on the filtration apparatus 100, 200 or the filtration component 604 of the print apparatus 600, 700. For example, at the end of a printing operation, the second surface/receiving surface 110 of the filtration apparatus 100, 200 or the filtration component 604 may be rotated (e.g. by rotating the roller or drum 112) without an electric field being applied by the electrode 102. In this way, debris (non-liquid contaminant 108) does not develop/accumulate on the second surface/receiving surface 110, and the blade 210 can be used to scrape any remaining contaminant from the second surface/receiving surface. The second surface 110 can therefore be thoroughly cleaned, ready for the next printing operation. Maintaining the second surface in a clean manner can help to improve the life of the second surface and of the apparatus 100, 200.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A print agent filtration apparatus to remove non-liquid contaminant from liquid carrier, the apparatus comprising:
an electrode having a first surface, wherein the electrode is to generate an electric field towards liquid carrier containing non-liquid contaminant; and
a second surface to accumulate non-liquid contaminant removed from the liquid carrier, the second surface being formed at least in part from a ceramic material and movable relative to the first surface;
wherein a gap between the first surface and the second surface is substantially constant over the extent of the first surface;
wherein the first surface and the second surface define a passage therebetween through which the liquid carrier may pass; and
wherein an electric field formed between the first surface and the second surface is to act on the liquid carrier, to thereby cause non-liquid contaminant to adhere to the second surface.

2. A print agent filtration apparatus according to claim 1, further comprising:
an inlet to receive the liquid carrier containing non-liquid contaminant; and
an outlet to allow filtered liquid carrier to flow away from the apparatus.

3. A print agent filtration apparatus according to claim 2, wherein the inlet comprises multiple inlet apertures positioned at regular intervals along the length of the second surface.

4. A print agent filtration apparatus according to claim 2, wherein the outlet comprises multiple outlet apertures positioned at opposite ends of the second surface.

5. A print agent filtration apparatus according to claim 1, wherein the second surface comprises, or is formed on, a surface of a drum, the drum being rotatable relative to the first surface.

6. A print agent filtration apparatus according to claim 5, wherein the drum is to rotate at a rate of between around 0.2 revolutions per minute and around 0.5 revolutions per minute.

7. A print agent filtration apparatus according to claim 1, further comprising:
a displacement element to displace non-liquid contaminant from the second surface.

8. A print agent filtration apparatus according to claim 7, wherein the displacement element comprises a blade;
wherein the second surface is moveable relative to the blade, such that the blade is to displace non-liquid contaminant from the second surface as the second surface moves relative to the blade.

9. A print agent filtration method to remove particles from liquid carrier, the method comprising:
supplying liquid carrier through a passage defined by a surface of an electrode and a ceramic particle collection surface, a gap between the electrode surface and the particle collection surface being substantially constant over the extent of the electrode surface;
applying a voltage to the electrode, thereby to generate an electric field between the electrode surface and the particle collection surface, and to cause particles from the liquid carrier to adhere to the particle collection surface.

10. A print agent filtration method according to claim 9, wherein the liquid carrier is supplied at a rate of between around 15 litres per minute and around 25 litres per minute.

11. A print agent filtration method according to claim 9, wherein the voltage suppled to the electrode comprises a voltage of between around 3.5 kV and around 4.5 kV.

12. A print agent filtration method according to claim 9, further comprising:
positioning a displacement member in engagement with particles adhered to the particle collection surface; and
moving the particle collection surface relative to the displacement member to displace adhered particles from the particle collection surface.

13. A print agent filtration method according to claim 9, further comprising:
enabling filtered liquid carrier to egress the passage.

14. A print apparatus comprising:
a print component to print onto a printable substrate during a printing operation; and
a filtration component to remove non-liquid contaminant from liquid carrier used in the printing operation, the filtration component comprising:
an electrode having an electrode surface;
a ceramic receiving surface to receive non-liquid contaminant removed from the liquid carrier, the receiving surface moveable relative to, and spaced apart from, the electrode surface to form a flow region through which the liquid carrier may pass;
wherein, when an electric current is applied to the electrode, an electric field is formed between the electrode surface and the receiving surface, thereby causing non-liquid contaminant in the liquid carrier to adhere to the receiving surface.

15. A print apparatus according to claim 14, wherein the filtration component further comprises a displacement member to displace non-liquid contaminant from the receiving surface; and
wherein the print apparatus further comprises:
a reservoir to receive filtered liquid carrier from the flow region; and
a receptacle to receive non-liquid contaminant displaced from the receiving surface.
